(19) United States
(12) Patent Application Publication
(10) Pub. No.: US 2004/0257176 A1
(43) Pub. Date: Dec. 23, 2004

(54) Mounting mechanism for high performance dielectric resonator circuits

(76) Inventors: Kristi Dhimiter Pance, West Boston, MA (US); Eswarappa Channabasappa, Acton, MA (US)

Correspondence Address: The Whitaker Corporation, Suite140, 4550 New Linden Hill Road, Wilmington, DE, 19808-2952, US

(21) Appl. No.: 10/431,085

(22) Filed: May 7, 2003

(51) Int. Cl. H01P 7/10

(52) U.S. Cl. 333/219.1; 333/234

(57) ABSTRACT

The invention is a method and apparatus for dissipating heat in a dielectric resonator circuit in which resonators are mounted to an enclosure by highly thermally and electrically conductive supports, such as metal rods, that pass through the longitudinal through hole in the center of the resonator. The supports preferably are attached within the through holes by a highly thermally conductive, but dielectric sleeve positioned between the support and the resonator. The rod or support has a diameter selected to minimize any reduction in quality factor, Q, for the circuit. Alternately, the support can be a highly thermally conductive dielectric and the inner wall of the through hole can be metalized.

### FIELD OF THE INVENTION

The invention pertains to dielectric resonators circuits, such as those used in microwave communications systems. More particularly, the invention pertains to techniques for improving heat dissipation in such circuits.

### BACKGROUND OF THE INVENTION

Dielectric resonators are used in many circuits, particularly microwave circuits, for concentrating electric fields. They can be used to form filters, oscillators, triplexers and other circuits.

FIG. 1 is a perspective view of a typical dielectric resonator of the prior art. As can be seen, the resonator 10 is formed as a cylinder 12 of dielectric material with a circular, longitudinal through hole 14. FIG. 2 is a perspective view of a microwave dielectric resonator filter 20 of the prior art employing a plurality of dielectric resonators 10. The resonators 10 are arranged in the cavity 22 of a conductive enclosure 24. The conductive enclosure 24 typically is rectangular, as shown in FIG. 2. The enclosure 24 commonly is formed of aluminum and is silver plated, but other materials also are well known. The resonators 10 may be attached, such as by adhesive, to the floor of the enclosure, but, more commonly are suspended above the floor of the enclosure by a low loss dielectric support, such as a post or rod. FIG. 3 is a cross-sectional side view of one of the resonators 10 mounted in the enclosure 24 of FIG. 2 via a dielectric rod 25, which may be made, for example, of aluminum. The rod 25 is attached to the floor 26 of the enclosure 24 via a plastic screw 27 that passes through the through hole of the resonator and a through hole in the rod 25 into a threaded hole in the enclosure 24. A washer 29 applies compression force from the screw 27 to the resonator and rod and the top of the rod is attached to the resonator 10.

Microwave energy is introduced into the cavity by an input coupler 28 coupled to an input energy source, such as a coaxial cable. Coupling between the input/output couplers and the dielectric resonators may be electric (e.g., capacitive), magnetic or both. The term electromagnetic coupling is used herein in the broadest sense, including electric coupling, magnetic coupling or a combination of both. Conductive separating walls 32 separate the resonators from each other and block (partially or wholly) coupling between physically adjacent resonators 10. Particularly, irises 30 in walls 32 control the coupling between adjacent resonators 10. Walls without irises generally prevent any coupling between adjacent resonators separated by those walls. Walls with irises allow some coupling between adjacent resonators separated by those walls. By way of example, the dielectric resonators 10 electromagnetically couple to each other sequentially, i.e., the energy from input coupler 28 couples into resonator 10a, resonator 10a couples with the sequentially next resonator 10b through iris 30a, resonator 10b couples with the sequentially next resonator 10c through iris 30b, and so on until the energy is coupled from sequentially last resonator 10d to the output coupler 40. Wall 32a, which does not have an iris, prevents the field of resonator 10a from coupling with physically adjacent, but not sequentially adjacent, resonator 10d on the other side of the wall 32a. Of course, dielectric resonator circuits are known in which cross coupling between non-sequentially adjacent resonators is desirable and is, therefore, allowed and/or caused to occur, but no such cross-coupling is illustrated in the exemplary embodiment of FIG. 2.

One or more metal plates 42 are attached to a top cover plate (the top cover plate is not shown) generally coaxially with a corresponding resonator 10 to affect the field of the resonator to set the center frequency of the filter. Particularly, plate 42 may be mounted on a screw 43 passing through a threaded hole in the top cover plate (not shown) of enclosure 24. The screw may be rotated to vary the spacing between the plate 42 and the resonator 10 to adjust the center frequency of the resonator. The sizes of the resonators 10, their relative spacing, the number of resonators, the size of the cavity 22, and the size of the irises 30 all need to be precisely controlled to set the desired center wavelength of the filter and the bandwidth of the filter.

An output coupler 40 is positioned adjacent the last resonator 10d to couple the microwave energy out of the filter 20 and into, for example, another coaxial connector (not shown). Signals also may be coupled into and out of a dielectric resonator circuit by other techniques, such as microstrips positioned on the bottom surface 44 of the enclosure 24 adjacent the resonators.

As is well known in the art, dielectric resonators and resonator filters have multiple modes of electrical fields and magnetic fields concentrated at different center frequencies. A mode is a field configuration corresponding to a resonant frequency of the system as determined by Maxwell's equations. In a dielectric resonator, the fundamental resonant mode frequency, i.e., the lowest frequency, is the transverse electric field mode, TE_{01δ} (or TE hereafter). Typically, it is the fundamental TE mode that is the desired mode of the circuit or system in which the resonator is incorporated. The second mode is commonly termed the hybrid mode, H_{11δ}0 (or H₁₁ hereafter). The H₁₁ mode is excited from the dielectric resonator, but a considerable amount of electric field lies outside of the resonator and, therefore, is strongly affected by the cavity. The H₁₁ mode is the result of an interaction of the dielectric resonator and the cavity within which it is positioned and has two polarizations. The H₁₁ mode field is orthogonal to the TE mode field. There are additional higher order modes, including the TM_{01δ} mode.

Typically, all of the modes other than the TE mode, are undesired and constitute interference. The H₁₁ mode and TM_{01δ} (transverse magnetic) mode, however, often are the only interference mode of significant concern because they tend to be rather close in frequency to the TE mode. The longitudinal through hole 14 in the resonator helps to push the frequency of the Transverse Magnetic mode upwards. However, during the tuning of a filter, the frequency of the Transverse Magnetic mode could be brought downward and close to the operating band of the filter. Particularly, as the tuning plate is brought closer to the resonator, the TM mode tends to drop in frequency and approach the TE mode frequency.

The remaining higher order modes usually have substantial frequency separation from the TE mode and thus do not cause significant interference with operation of the system.

One shortcoming of prior art resonators and resonator circuits is that they can have poor mode separation between the desired TE mode and the undesired TM₀₁ and H₁₁ modes. Further, prior art dielectric resonator circuits, such as the filter shown in FIG. 2, suffer from poor quality factor, Q, due to the presence of separating walls and coupling screws. Q essentially is an efficiency rating of the system and, more particularly, is the ratio of stored energy to lost energy in the system. The fields generated by the resonators touch all of the conductive components of the system, such as the enclosure 20, tuning plates 42, internal walls 32 and 34, and adjusting screws 43, and inherently generate currents in those conductive elements. Those currents essentially comprise energy that is lost from the circuit.

Even further, the electrical fields in the resonators generate heat within the resonators. In low power microwave circuits, the heat is not significant enough to require special design elements to assure adequate heat dissipation. However, in high power microwave circuits, the need to dissipate the heat that is generated in the resonators becomes a design concern. Particularly, as the temperature of a dielectric resonator increases, its electrical properties change. Obviously, this is undesirable. The dielectric resonators themselves and the low loss dielectric supports on which they are mounted to the enclosure have very low thermal conductivity. Therefore, even though the enclosure may be highly thermally conductive (e.g., it may be formed of silver plated aluminum), there is no efficient path for the heat from the resonators to the enclosure.

One technique for improving heat dissipation for high power dielectric resonator circuits is disclosed in Nishikawa, T., Wakino, K., Tsunoda, K., and Ishikawa, Y., Dielectric High-Power Bandpass Filter Using Quarter-Cut TE_{01δ} Image Resonator for Cellular Base Stations, Transactions on Microwave Theory and Techniques, Vol. MTT-35, Dec. 12, 1987. This reference discloses a dielectric resonator filter which uses quarter-cut dielectric resonators, each attached to two perpendicular metal plates. The metal plates are attached to the opposite end faces of the quarter-cut resonators and also are attached to the enclosure. The two plates mirror the quarter-cut resonators to form a circuit with the appropriate electromagnetic properties and simultaneously provide a highly thermally conductive path from the resonators through the metal plates to the metal enclosure. However, contacting the resonators to the metal plates significantly reduces the Q of the circuit. The authors reported an unloaded Q of 7000 at 880 MHz and an insertion loss and attenuation level of 0.37 dB and 95 dB, respectively, for an eight-pole elliptic function type filter of their design.

It is an object of the present invention to provide an improved dielectric resonator circuit.

It is another object of the present invention to provide a dielectric resonator circuit with improved heat dissipation.

It is an object of the present invention to provide an improved high-power dielectric resonator circuit.

It is another object of the present invention to provide a dielectric resonator circuit with improved heat dissipation, quality factor and spurious response.

It is yet a further object of the present invention to provide improved mechanical stability.

### SUMMARY OF THE INVENTION

The invention is a method and apparatus for dissipating heat in a dielectric resonator circuit. In accordance with the invention, the resonators are mounted to the enclosure by highly thermally and electrically conductive supports, such as metal rods, that pass through the longitudinal through hole in the center of the resonator. The supports preferably are attached within the through holes by a highly thermally conductive, but dielectric sleeve positioned between the support and the resonator. The rod or support has a diameter selected to minimize any reduction in quality factor, Q, for the circuit. Alternately, the support can be a highly thermally conductive dielectric and the inner wall of the through hole can be metallized.

The present invention is effective in connection with circuits utilizing conventional cylindrical dielectric resonators, but are particularly effective in connection with newer conical resonators. Particularly, if a metal rod passes from one side to the other of the enclosure through the through hole of a conical dielectric resonator, it actually tends to help improve spurious response of the system by weakening and shifting the TM_{01δ} mode away from the TE mode.

### BRIEF DESCRIPTION OF THE DRAWINGS

FIG. 1 is a perspective view of a cylindrical dielectric resonator in accordance with the prior art.

FIG. 2 is a perspective view of an exemplary microwave dielectric resonator filter in accordance with the prior art.

FIG. 3 is a cross-sectional view of one of the resonators mounted to the enclosure in FIG. 2 in accordance with the prior art.

FIG. 4 is a perspective view of a conical dielectric resonator in connection with which use of the present invention is particularly suitable.

FIG. 5A is a cross sectional view of the conical dielectric resonator of FIG. 4 illustrating the distribution of the TE mode electric field.

FIG. 5B is a cross sectional view of the dielectric resonator of FIG. 4 illustrating the distribution of the H₁₁ mode electric field.

FIG. 6 is a side cross sectional view of another conical dielectric resonator in connection with which use of the present invention is particularly suitable.

FIG. 7 is a side view (with one wall of the enclosure removed for purposes of visibility) of a dielectric resonator circuit in accordance with the present invention.

FIG. 8 is a perspective view of the dielectric resonator circuit of FIG. 7 (with one wall of the enclosure removed for purposes of visibility).

FIG. 9A is a side view (with one wall of the enclosure removed for purposes of visibility) of a dielectric resonator circuit in accordance with another embodiment of the present invention.

FIG. 9B is a side view (with one wall of the enclosure removed for purposes of visibility) of a dielectric resonator circuit similar to that of FIG. 9A showing a further improvement in accordance with the present invention.

FIG. 9C is a more detailed side view of the cross-coupling tuning screw in the embodiment of FIG. 9B.

FIG. 10 is a side view (with one wall of the enclosure removed for purposes of visibility) of a dielectric resonator circuit in accordance with yet another embodiment of the present invention.

FIG. 11 is a side view (with one wall of the enclosure removed for purposes of visibility) of a dielectric resonator circuit in accordance with yet another embodiment of the present invention.

### DETAILED DESCRIPTION OF THE INVENTION

A. Conical Resonators and Circuits Using Them

U.S. patent application Ser. No. 10/268,415, which is fully incorporated herein by reference, discloses new dielectric resonators and circuits using such resonators. One of the key features of the new resonators disclosed in the aforementioned patent application is that the field strength of the TE mode field outside of and adjacent the resonator varies along the longitudinal dimension of the resonator. As disclosed in the aforementioned patent application, a key feature of the new resonators that helps achieve this goal is that the cross-sectional area of the resonator measured parallel to the field lines of the TE mode varies along the longitude of the resonator, i.e., perpendicular to TE mode field lines. In preferred embodiments, the cross-section varies monotonically as a function of the longitudinal dimension of the resonator. In one particularly preferred embodiment, the resonator is conical, as discussed in more detail below. Even more preferably, the cone is a truncated cone.

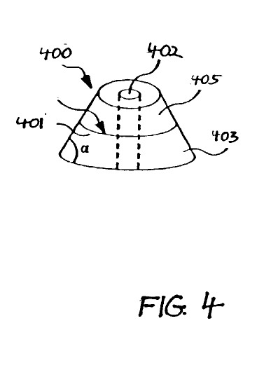

FIG. 4 is a perspective view of an exemplary embodiment of a dielectric resonator in accordance with the aforementioned patent application. As shown, the resonator 400 is formed in the shape of a truncated cone 401 with a central, longitudinal through hole 402. As in the prior art, the primary purpose of the through hole is to suppress the Transverse Magnetic (TM₀₁) mode. The TM₀₁ mode can come quite close in frequency to the working band of the filter (i.e., the frequency of the TE mode) during tuning of the filter when using conventional, cylindrical resonators. However, conical resonators destroy the homogeneity of epsilon filled space in the longitudinal direction of the resonator. This aspect of conical resonators together with a longitudinal through hole of an appropriate diameter in the resonator can substantially reduce the magnitude of TM₀₁ mode excitation compared to conventional cylindrical resonators. The conical shape causes the TE mode field to be located in a physically spaced volume from the H₁₁ mode field.

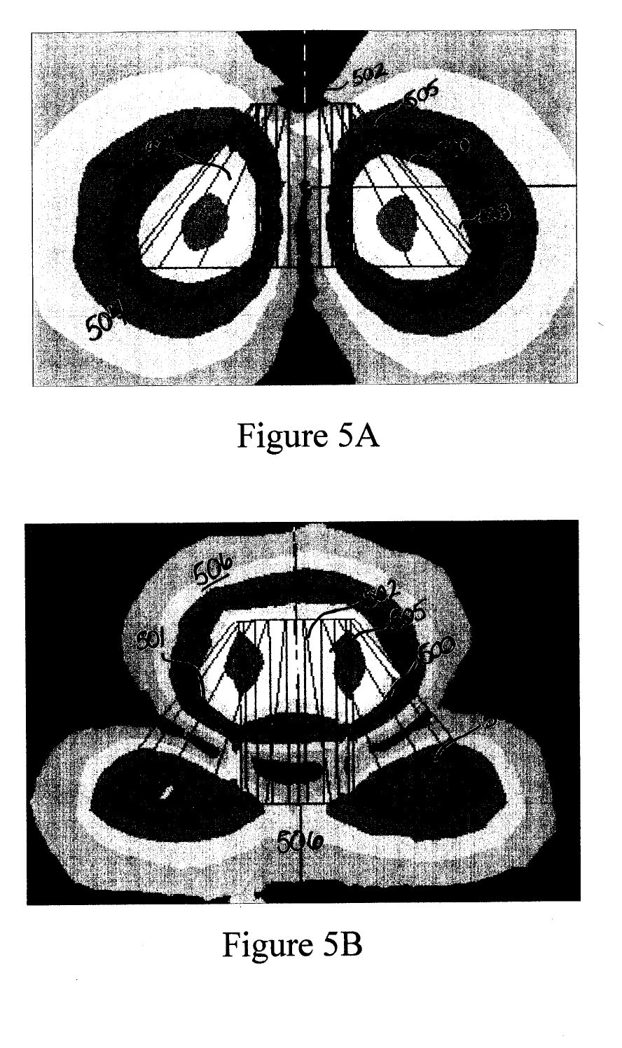

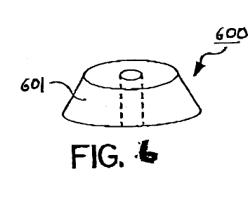

Referring to FIGS. 5A and 5B, the TE mode electric field 504 (FIG. 5A) tends to concentrate in the base 503 of the resonator because of the transversal components of the electric field. However, the H₁₁ mode electric field 506 (FIG. 5B) tends to concentrate at the top (narrow portion) 505 of the resonator because of the vertical components of the electric field. The longitudinal displacement of these two modes improves performance of the resonator (or circuit employing such a resonator) because the conical dielectric resonators can be positioned adjacent other microwave devices (such as other resonators, microstrips, tuning plates, and input/output coupling loops) so that their respective TE mode electric fields are close to each other and strongly couple while their respective H₁₁ mode electric fields remain further apart from each other and, therefore, do not couple to each other nearly as strongly. Accordingly, the H₁₁ mode would not couple to the adjacent microwave device nearly as much as in the prior art, where the TE mode and the H₁₁ mode are located much closer to each other.

In addition, the mode separation (i.e., frequency spacing) is increased in the conical resonators of the present invention.

The radius of the longitudinal through hole should be selected to optimize insertion loss, volume, spurius response, and other properties. Further, the radius of the longitudinal through hole can be variable. For instance, it may comprise one or more steps.

FIG. 6 shows an even more preferred embodiment of the conical resonator of application Ser. No. 10/268,415 in which the body 601 of the resonator 600 is even further truncated. Particularly, relative to the exemplary resonator illustrated in FIG. 4, one may consider the resonator of FIG. 6 to have its top removed. More particularly, the portion of the resonator in which the H₁₁ mode field was concentrated in the FIG. 4 embodiment is eliminated in the FIG. 6 embodiment. Accordingly, not only is the H₁₁ mode physically separated from the TE mode, but it is located outside of the dielectric material and, therefore, is substantially attenuated as well as pushed upwardly in frequency.

Hence, in contrast to the prior art cylindrical resonators, the problematic H₁₁ interference mode is rendered insignificant in the conical resonators of the aforementioned patent application with virtually no incumbent attenuation of the TE mode. As discussed in detail in the aforementioned patent application, the larger mode separation combined with the physical separation of the TE and H₁₁ modes enables the tuning of the center frequency of the TE mode without significantly affecting, the center frequency of the H₁₁ mode. Conical resonators also substantially improve the suppression of the TM₀₁ mode, which is the other spurious mode that often is of concern. In fact, because a conical resonator destroys the homogeneity in the longitudinal direction of the resonator and also because an appropriately dimensioned through hole in the resonator substantially attenuates the TM₀₁ mode, the TM₀₁ mode is actually quite difficult to excite in a conical resonator and can be excited only if the tuning plate is very close to the resonator, i.e., almost touching. Such close positioning of a tuning plate to the resonator is undesirable for other reasons. For example, it will significantly reduce the quality factor Q of the operating TE mode. Thus, conical resonators generally are superior to conventional cylindrical resonators with respect to minimizing interference from spurious modes such as the TM₀₁ and H₁₁ modes. On the other hand, it is quite easy to support the TM₀₁ mode near the frequency of the TE mode in a conventional cylindrical resonator through the interactions of the tuning plate, tuning screws, cavity and the cylindrical resonator.

U.S. patent application Ser. No. 10/268,415 discloses a number of other embodiments in accordance with the principles of the invention disclosed therein as outlined above, all of which are suitable for application of the present invention.

B. Heat Dissipation

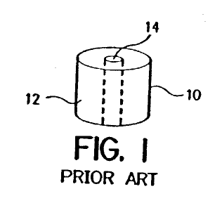

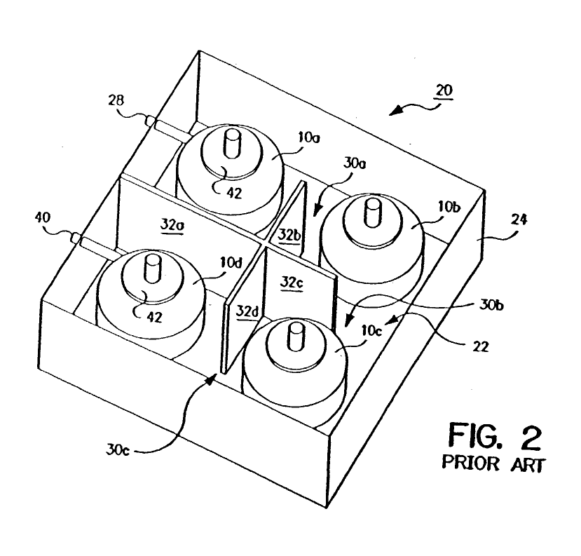

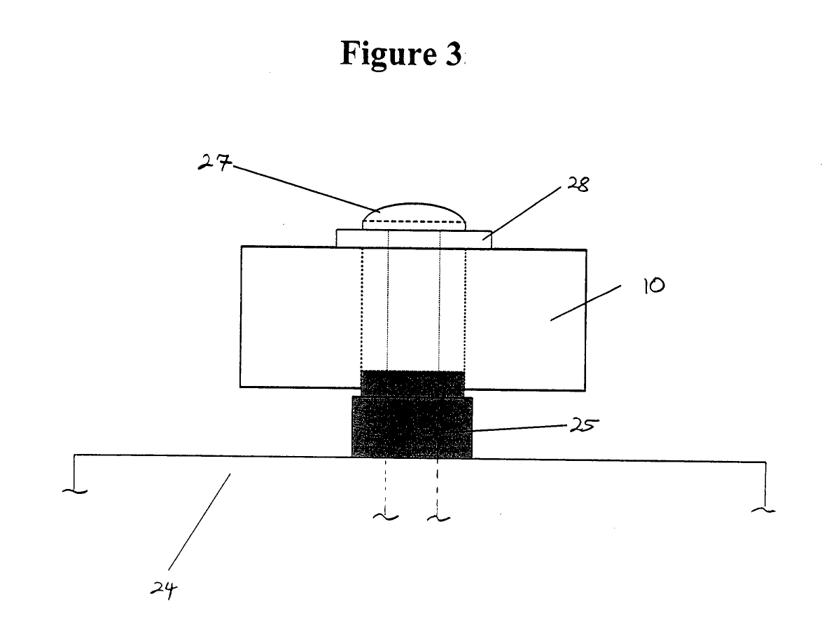

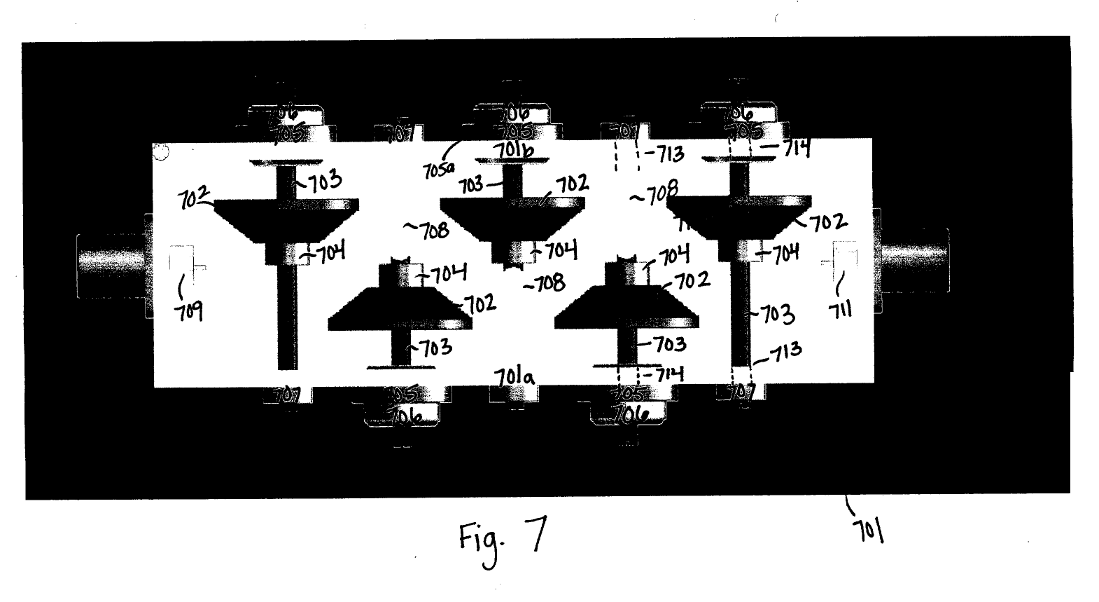

FIG. 7 is a perspective view of an exemplary conical dielectric resonator microwave filter in accordance with the present invention. While the present invention is particularly beneficial when employed in connection with conical resonators because of some of their unique properties, as will be discussed further below, this embodiment is merely exemplary. The present invention is equally applicable to other types of resonators, including conventional cylindrical resonators such as illustrated in FIG. 1 of the present specification and all of the various resonators disclosed in aforementioned U.S. patent application No. 10/268,415. As shown, the filter 700 comprises a rectangular enclosure 701. One wall has been removed for purposes of allowing the internal components to be seen, but it will be understood that the actual enclosure would include the final wall to completely enclose and protect the internal circuit components. A plurality of resonators 702 are arranged within the housing in any configuration suitable to achieve the performance goals of the circuit. If the resonators are conical resonators, preferably, each resonator is longitudinally inverted relative to its adjacent resonator or resonators, as shown. The primary reasons for the preference of inverting each conical resonator relative to the adjacent resonators are so that the TE mode electric fields can be brought even closer to each other and to reduce the size of the circuit. Specifically, the resonators can be packed into a smaller space by alternately inverting them. Also, since the TE mode fields are concentrated in the bases of the resonators, the field of one conical resonator is displaced from the field of the adjacent, inverted conical resonator longitudinally (the z axis in FIG. 7) as well as transversely (the x and y axes in FIG. 7). Thus, by inverting adjacent conical resonators and spacing the resonators very close to each other in the lateral direction, the base of one resonator may be positioned almost directly above the base of an adjacent resonator such that there is almost no lateral (x,y) displacement between the bases of the two resonators, only a longitudinal displacement. Hence, the TE mode field of one resonator can be placed right above the TE mode field of the adjacent resonator, if particularly strong coupling is desired. On the other hand, if less coupling is desired, the displacement between the two resonators can be increased longitudinally and/or laterally.

In prior art circuit designs utilizing, for example, cylindrical resonators, in which the TE field strength generally did not vary along the height of the resonators (except at the very ends of the resonators), there was generally little need or benefit to longitudinal adjustability of the resonators relative to each other.

FIG. 7 schematically shows a generic input coupler 709 through which microwave energy is supplied to the circuit. The input coupler 709, for instance, may receive energy from a coaxial cable (not shown) connected to the coupler outside of the enclosure. The coupler 709 is positioned through the wall of the enclosure near the first resonator, and the output is received at an output coupler 711 positioned near the last resonator. The couplers may be any other coupling means known in the prior art or discovered in the future for coupling energy into a dielectric resonator, including microstrips formed on a surface of the enclosure or coupling loops.

The resonators 702 are mounted to the enclosure via thermally and electrically conductive rods 703 that, preferably pass completely though the enclosure from one side wall 701 a to the opposing side wall 701 b. In a preferred embodiment, the rods 703 are metallic and pass completely through holes 713, 714 in the opposing enclosure walls. The rods also pass completely though the longitudinal through holes 716 in the resonators 702. A highly thermally conductive dielectric insert 704 preferably is positioned in and contacting the inner wall of the through hole in the resonator and has a central longitudinal through-hole through which the metal rod 703 passes contactingly. The insert 704 should be compliant so as to be able to adapt to and absorb any relative changes in size of the rod and the resonator through hole that might occur due to differences in the coefficients of thermal expansion of the rod and the resonator. Particularly, the rods and the resonators are constructed of very different materials and thus are likely to have significantly different coefficients of thermal expansion. The inserts 704 also prevent direct contact of the electrically conductive rod with the dielectric resonator, which can significantly reduce the Q of the circuit. However, in some circuits such contact may be useful. Teflon has been found to be a particularly suitable material for the insert 704. In alternate embodiments, the insert could be replaced with a layer of compliant adhesive with good thermal conductivity.

The highly thermally conductive rods 704 and inserts 705 provide an efficient thermal path from the resonators to the enclosure through which heat can be rapidly dissipated from the resonators, thus enabling high power circuits to be designed that will not overheat. An added benefit of using a material for the rods 704, such as metal, that is highly thermally-conductive is that it has very high torsional and bending strength for firmly holding the resonator pucks. Particularly, dielectric resonator circuits are commonly mounted outdoors and, thus, can be subjected to severe environmental conditions and rough handling during installation and operation. Accordingly, the strength of the rods that hold the resonator pucks is a significant design concern.

As noted previously, the enclosures commonly are formed of aluminum plated with silver and, therefore, are highly thermally conductive themselves. As discussed in detail in aforementioned patent application Ser. No. 10/268,415, when using conical resonators in a circuit, the enclosure may be formed of a plated plastic material. In accordance with the present invention, preferably, the plastic material is highly thermally conductive. However, the enclosure is a relatively large body that, even if not highly thermally conductive, would normally be able to dissipate the heat efficiently enough to the surrounding air to avoid overheating. In the past, the problem has been the lack of an efficient heat path from the resonators to the housing. The present invention provides such a path as well as many other advantages as discussed more fully below.

Also, preferably, the rod is threaded at least at one end thereof where it passes through the through hole 713 in the enclosure wall. The through hole 713 in the enclosure wall is matingly threaded so that the resonator can be longitudinally adjusted by rotation of the rod from without the enclosure. For instance the end of the rod may be provided with a slot 717 or similar impression for engagement by a screwdriver so that the rod can be easily rotated to cause the resonator to be longitudinally adjustable without the need to access the inside of the enclosure. A locking nut 707 may be provided on the threaded rod to hold the rod in place once the resonator is finally positioned.

Providing longitudinal adjustability of the conical resonators, allows the positions of the resonators to be adjusted relative to each other and to the enclosure which provides adjustability of the resonators coupling strength to each other, and thus, of the performance parameters of the circuit, such as center frequency and bandwidth as discussed in detail in aforementioned U.S. patent application Ser. No. 10/268,415. This adjustability enables controlled strong coupling, whereby lowpass or highpass filters can be replaced with very broad bandpass or very broad band-stop filters that are almost lossless.

The rods also may be threaded where they pass through the resonators 702 and/or inserts 704 and the insert and/or the rod are matingly threaded. Also, the insert may be internally and externally threaded so that it is separately longitudinally adjustable relative to the resonator and/or the rod, thus providing individual adjustability of each of the resonator 702, rod 703, and insert 704 relative to each other and the enclosure. However, it has been determined that the formation of threads on the rod near the insert and resonator as well as threads within the insert and resonator through hole themselves are not necessary and create unnecessary mechanical complications. In at least one preferred embodiment of the invention, the insert and through hole in the resonator are not threaded and the rod is not threaded in the vicinity of the resonator and insert. These elements can either not have individual longitudinal adjustability relative to each other or can be sized to provide friction fits therebetween so that they are still individually longitudinally adjustable relative to each other without introducing the mechanical complications of making all of the them threaded.

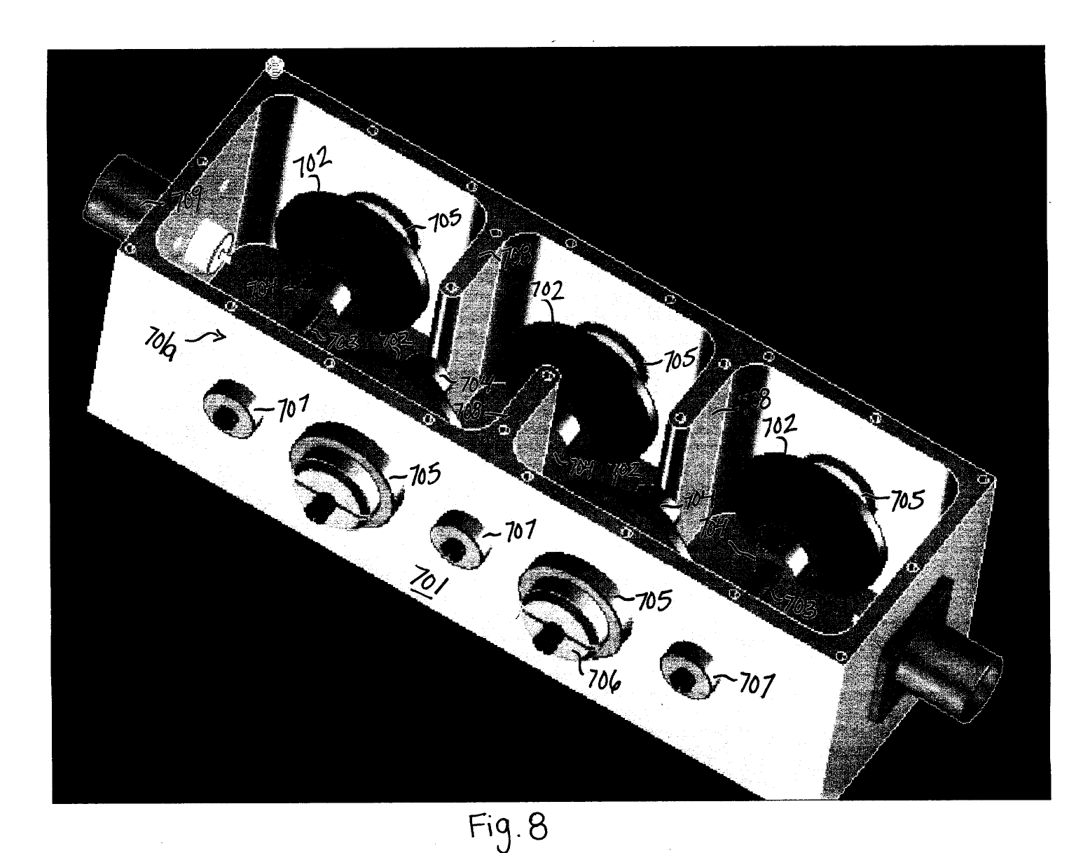

If the circuit contains separating walls, such as walls 708, the rods 703 can pass through holes in the separating walls, as illustrated in connection with the three middle resonators. This aspect of the invention is best seen in FIG. 8. Preferably, although, not necessarily, the separating walls 708 are thicker than the diameter of the rods 703 so that the rods are completely encased within the separating walls. If the rod is thicker than the wall such that it fully interrupts the wall and is partially exposed beyond the wall, and, particularly, if the rod is threaded, the ground path between the rod and the enclosure can be poor. On the other hand, making the separating walls thicker generally slightly lowers the overall Q of the circuit because the walls will be closer to the resonators. However, the sacrifice in lowered Q is likely to be rather small and, therefore, worth the tradeoff for improved ground connection.

The system may further include circular conductive tuning plates 705 adjustably mounted on the enclosure 701 for longitudinal adjustment relative to the bases of the resonators 702. As is well known in the art, the relative position of tuning plates such as plates 705 to the resonators affects the center frequency of the resonator and are used for tuning the center frequency of the circuit. Preferably, these plates 705 have a substantial longitudinal dimension (e.g., greater than the thickness of the enclosure side walls 701a and 701b). The plates may have threaded side walls 705a adapted to mate with correspondingly threaded through holes 714 in the enclosure 701. Thus, the tuning plates 705 are longitudinally adjustable relative to the bases of the resonators by rotation of the plates in their respective holes 714. However, note that, if the rods are threaded at both ends where they meet with the respective holes 713 and 714 in the opposite side walls 701 a and 701 b of the enclosure, then the threads must be very precisely formed so that there is no variability between the longitudinal movement of the rod corresponding to a given amount of rotation relative to the two holes 713 and 714 since this would cause binding and potential mechanical failure of the rods. In order to avoid this problem and/or the need for expensive, high precision machining, the rod should be threaded at only one end. Alternately, the rod is threaded at both ends, but the tuning plate bears threads to mate with the rod in its internal through hole, but its outer side wall is smooth and makes only a friction fit with the hole 714 in the enclosure. FIGS. 7 and 8 illustrate this last mentioned embodiment. Particularly, the both ends of the rod 703 are threaded so that the resonator is longitudinally adjustable by rotation of the rod relative to the housing in hole 713 and the tuning plate 705 is longitudinally adjustable relative to the resonator 702 by rotation of the tuning plate 705 relative to the rod 703. However, the tuning plate will not bind within the hole 714 in the enclosure because that hole is not threaded and the outside side wall 701 a of the tuning plate rides smoothly within the hole 714. Preferably, the rods 703 extend completely through and beyond the tuning plates 705 so that another locking nut 706 can be placed on the rod to lock the tuning plate in its final position.

The electrically conductive rod also helps suppress the spurious TM_{01δ} mode. Usually the TM_{01δ} mode is already well suppressed as a result of a properly dimensioned longitudinal through hole in the resonator. However, if, during tuning, the tuning plate is brought very close to the resonator, particularly, a conventional cylindrical resonator, it creates boundary conditions favorable to exciting the TM_{01δ} mode near the tuning band (i.e., near the frequency of the TE mode). The TM_{01δ} mode is concentrated in the center of the resonator in the longitudinal direction. Therefore, it passes through the through hole. The presence of a good electrical conductor in the through hole such as the support rod 703 forces the field strength toward zero at the rod. The rod is most effective in helping suppress the TM_{01δ} mode if it passes completely into and through the tuning plate, as illustrated in the drawings.

Circuit simulations of the circuit illustrated in FIGS. 7 and 8 show an expected Q of 12,000 at a center frequency of about 2 GHz, which is a substantial improvement over prior art circuits.

In alternate embodiments of the invention, the supports for the resonators may be formed partially of more conventional materials such as alumina, Teflon or polycarbonate and plated or otherwise coated with a metal or other highly electrically and thermally conductive material. As an even further alternative, an alumina, Teflon or polycarbonate support rod can be hollowed out, such as by drilling, or cast or molded as a hollow rod and a metal insert can be placed within the hollow portion of the rod. If the metal (or other highly thermally conductive material) rod is placed inside of a ceramic or plastic material, it is preferable that a ceramic or plastic material with high thermal conductivity be selected in order to promote good thermal conductivity from the dielectric resonator to the enclosure. However, if the metal of other highly conductive material is coated on the outside of the ceramic or plastic material, the thermal conductivity of the ceramic or plastic material is not as significant since the heat largely will be conducted from the dielectric resonator to the enclosure without passing through the internal ceramic or plastic material.

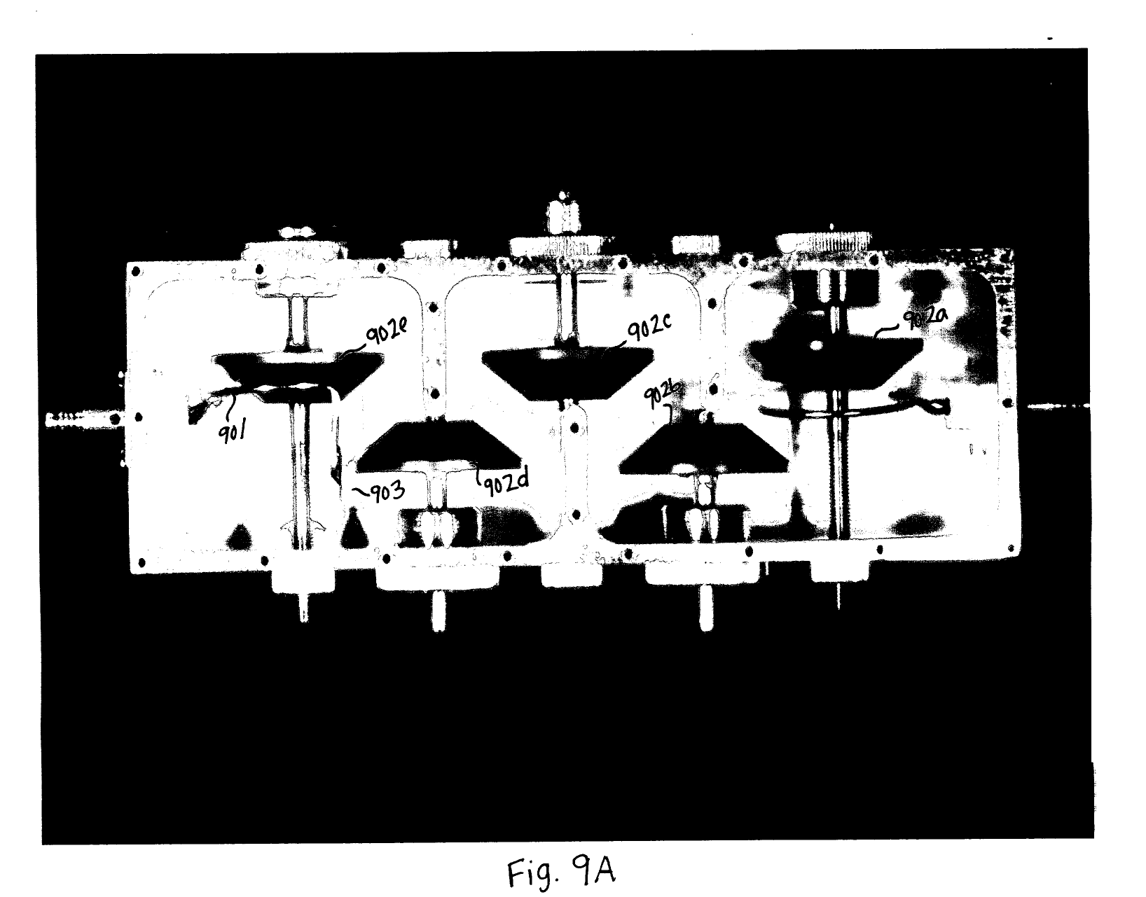

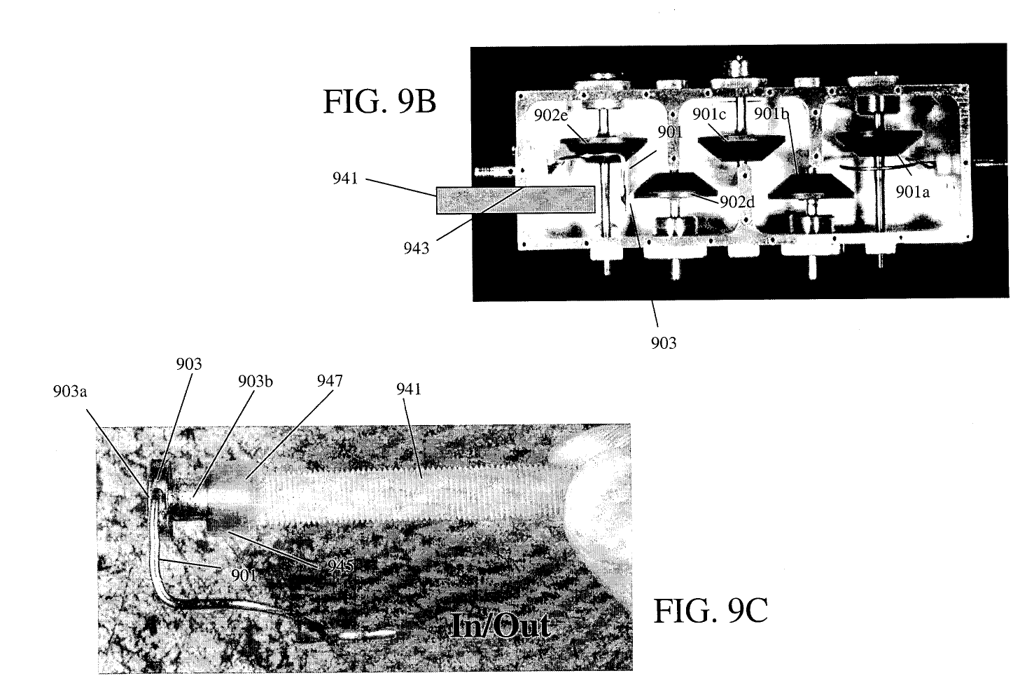

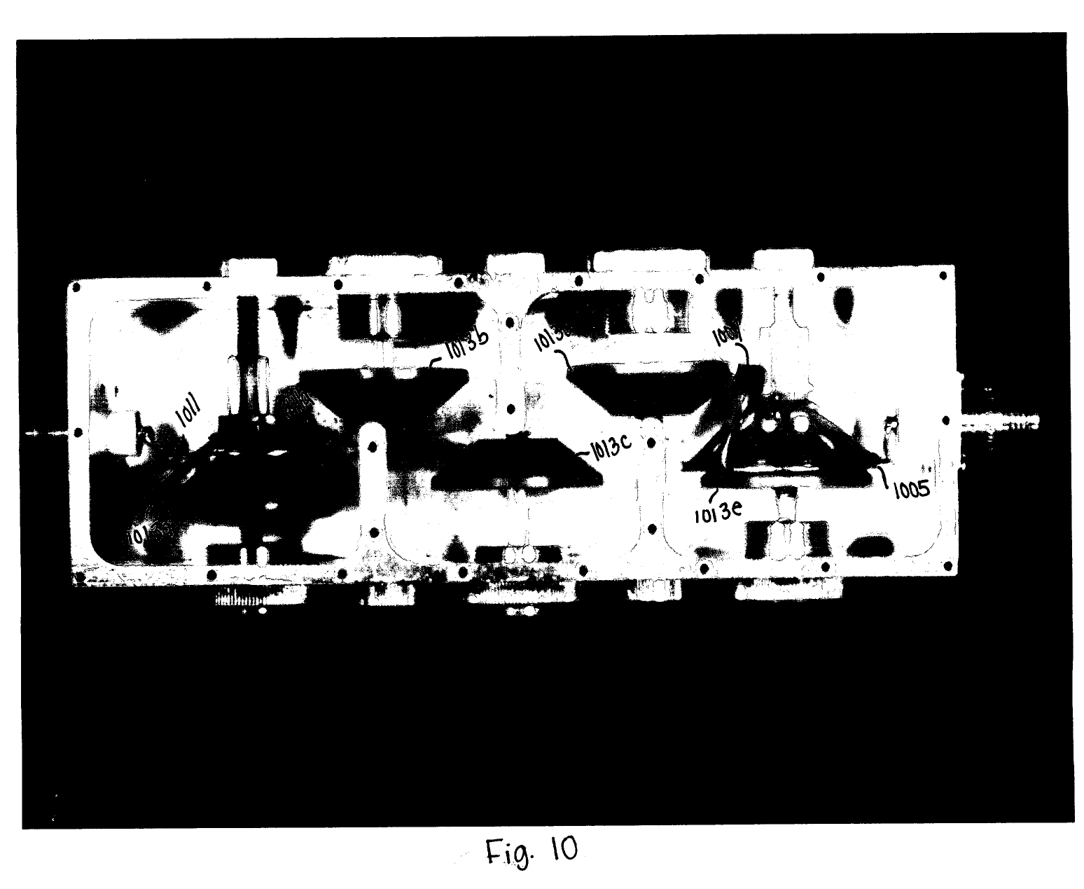

FIG. 9A shows one practical embodiment of the present invention, including at least one additional feature to those previously discussed. Particularly, this embodiment includes most of the basis components of the dielectric resonator circuit illustrated in FIGS. 7 and 8. Additional features include a modified output coupling loop system in which the output coupler 911 comprises a coupling element in the form of a coupling loop 901 that curves around the last dielectric resonator 902e. It is similar to that discussed above in connection with FIG. 7 and 8, except for the addition of a second coupling element in the form of a copper plate 903 suspended from the end of the main coupling loop 901 and positioned adjacent to the second to last resonator 902d. The plane of the plate 903 is oriented parallel to the longitudinal axes of the dielectric resonators 902a-902e and perpendicular to the plane defined by the longitudinal axes of all of the resonators. However, other configurations are possible.

The plate 903 realizes electric coupling to the second to last resonator 902d, while the wire loop 901 realizes magnetic coupling to the last resonator 902e. In accordance with this embodiment, the coupling into and out of the filter is asymmetric, which yields a symmetrically-shaped filter response.

FIGS. 9B and 9C illustrate a further modification in accordance with the present invention. In accordance with this aspect of the invention, an elongate cross-coupling tuning element, such as a threaded screw 941, is provided through a matingly threaded hole 943 in the wall of the enclosure. The cross-coupling tuning plate 903 comprises a circular plate 903a extending from a cylinder 903b having a smaller diameter than the plate 903a. The screw 941 has a cylindrical hollow portion 945 at its distal end 947 sized and shaped so that cylinder portion 903b of the cross-coupling plate 903 can fit within it. In operation, the screw 941 is positioned in the wall of the enclosure so that the hollow portion 945 engages the cylinder 903b. By rotating the screw 941 in the hole 943, the distal end 947 of the screw advances or retracts longitudinally, thereby either butting up against cylinder 903b and pushing the cross-coupling tuning plate 903 forward against the resilient force of the wire 901 or allowing the wire to resiliently return the plate 903 to its rest position. The cylinder 903b can simply fit loosely within the cylindrical hollow portion 945 of the screw 941 so that the screw can be rotated to push the tuning plate 903 without also rotating the tuning plate. In other embodiments in which the tuning screw can both push and pull the tuning plate in either direction from the rest position dictated by the resilient force of the wire 901, the cylinder 903b can be fixed to the tuning screw 941 in any number of well known ways that will still allow for relative rotation between the screw 941 and the plate 903, such as a pin with a rotational bearing.

In accordance with this aspect of the invention, cross-coupling between the coupler and the resonator 902d can be adjusted simply by rotating the proximal end 946 of the screw 941 without opening the enclosure.

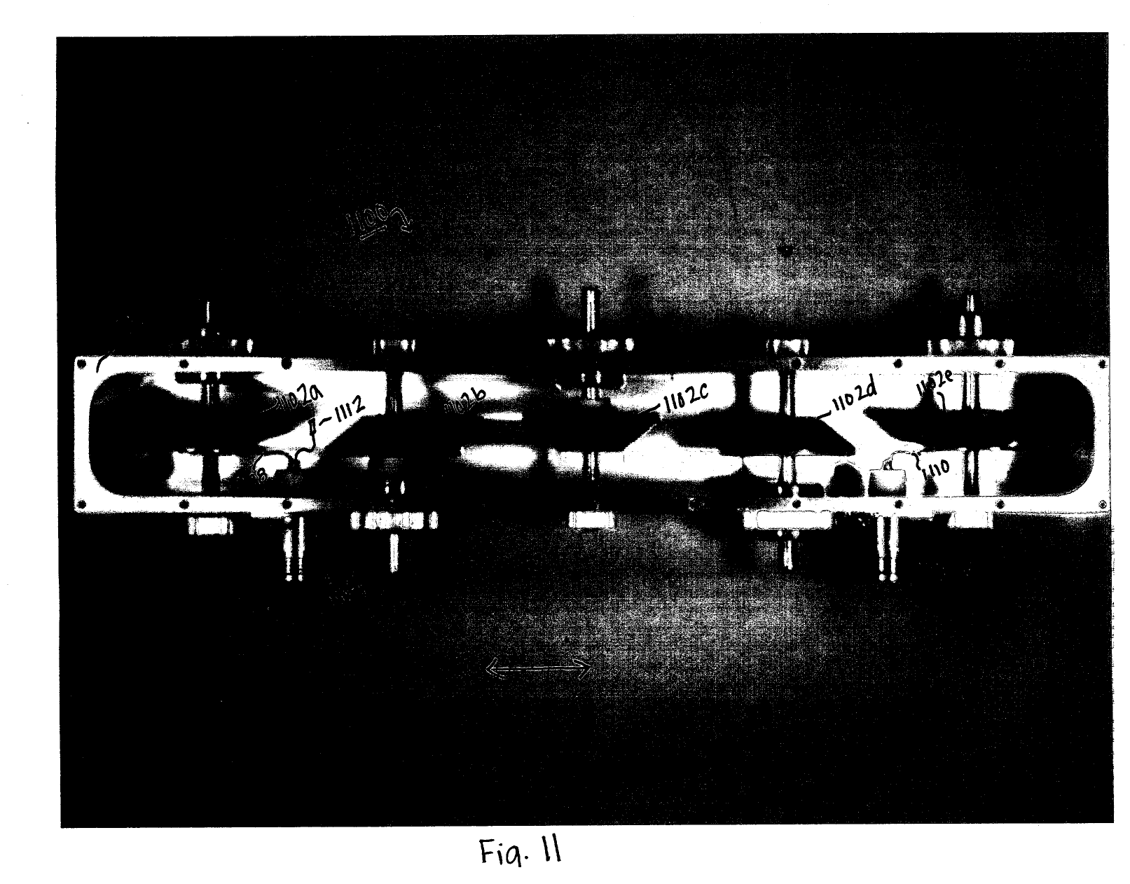

FIG. 10 illustrates another practical embodiment of the invention. The output coupling loop 1005 includes a copper plate 1007 and is similar in all relevant respects to the output coupling loop system shown in the FIG. 9 embodiment. The input coupling loop 1011 differs however. In the embodiment of FIG. 10, the portion of the input coupling wire 1011 a that is adjacent the second resonator 1013b is bowed outwardly and upwardly compared to the arc of the remainder of the coupling wire 1011 to bring that portion 1011 a closer to the second resonator 1013b. This creates some magnetic coupling of the wire loop to the second resonator as well as the first resonator 1013a. This helps to enhance the selectivity of the filter on the left side of the circuit.

FIG. 11 illustrates another practical embodiment of the invention. The embodiment of FIG. 11 differs from the previously discussed embodiments in several significant ways. First, the input connector 1104 is physically positioned on the housing 1101 between the first and second resonators 1102a and 1102b. Likewise, the output connector 1106 is similarly physically positioned in the housing 1101 between the second to last and the last resonators 1102d and 1102e. Furthermore, the circuit has no separating walls between the resonators (i.e., it is an irisless enclosure). Finally, the lateral spacing between the resonators (i.e., in the direction of double headed arrow 1115 in FIG. 11) is non-uniform. For instance, in this particular embodiment, the first two resonators 1102a and 1102b are closer to each other in the transverse direction than the second and third resonators 1102b and 1102c are to each other. Likewise, the last two resonators 1102d and 1102e are closer to each other than resonators 1102c and 1102d, for instance, are to each other.

Each of these modifications is significant. For instance, the placement of the connectors 1104 and 1106 between two adjacent resonators allows for greater freedom and options for coupling energy into and out of the circuit. For instance, referring to the input coupler 1104, it has a first coupling loop 1108 designed and positioned to magnetically couple to the first resonator 1102a as previously described in connection with other embodiments discussed in this specification. However, if desired, a second coupling element, such as coupling element 1112, can be coupled to the connector 1104 and positioned to couple with the second resonator 1102b. Thus, for instance, as shown in FIG. 11, a separate coupling plate 1112, similar to coupling plate 903 in FIG. 9 can be positioned adjacent the second resonator 1102b to provide electrical cross coupling between the connector 1104 and the second resonator 1102b.

In many circuits, such additional cross coupling is desirable to improve attenuation. In other circuits for which such additional cross coupling is unnecessary or undesirable, the second coupling element 1112 can simply be omitted. For example, output coupler 1106, although positioned between the last two resonators 1102d and 1102e and capable of supporting a second coupling element, like connector 1104, only has one coupling element, i.e., loop 1110, which magnetically couples to the last resonator 1102e.

With respect to the non-uniform lateral spacing of the resonators, it is a desirable feature because it is often the case that different coupling strength is needed between different pairs of adjacent resonators. For instance, it is common in dielectric resonator circuit design to need stronger coupling between the first two resonators and/or the last two resonators than it is between the intermediate resonators. In the prior art, this has typically been achieved by using irises of different dimensions between the various resonators. However, in the present invention, because coupling strength between the resonators is highly adjustable by longitudinal adjustment of the resonators relative to each other, circuits can commonly be designed without irises. This is a substantial advantage because the walls used to form the irises there between to limit coupling reduce the quality factor of the circuit. Essentially they generate losses in the circuit. Of course, the coupling strength between any pair of resonators can be made stronger than between any other pair of resonators by longitudinally adjusting the various resonators with respect to each other, as previously described in the specification. However, the change in coupling strength achieved by longitudinal adjustment of the resonators relative to each other is fairly small and really constitutes fine tuning. In practical embodiments of the present invention, longitudinal adjustment of the resonators relative to each other typically can achieve changes in coupling strength of 10 to 15%. As those of skill in the art will readily recognize, small differences in the transverse spacing of the resonators typically will have a very significant effect on coupling. Accordingly, by using nonuniform transverse spacing of the resonators, the base coupling strength between any two resonators can be set more precisely. For instance, it is often the case in dielectric resonator circuits that coupling strength between the first two resonators and the last two resonators should be much stronger than the coupling between the intermediate resonators. Accordingly, the circuit enclosure can be designed so that the first two resonators and the last two resonators have a smaller transverse spacing than the other adjacent resonators. In this manner, the fine tuning accomplished by the longitudinal adjustment of the resonators relative to each other can start from a more suitable base coupling between the resonators. The substantial tunability of resonators circuits in accordance with the present invention and, particularly, the ability to eliminate the need for irises has substantial secondary practical benefits also. For instance, the elimination of irises greatly simplifies the machining of the enclosure 1101. Accordingly, the circuits can be manufactured more quickly and inexpensively due to the elimination of much of the complex machining of the enclosures.

Thus, whereas the embodiments of FIGS. 9 and 10 also provide cross coupling between the connector and a second resonator, the FIG. 11 embodiment has the additional advantage in that the two branches from the connector, e.g. 1108 and 1112, can be positioned independently of each other, such that the coupling of the first resonator 1102a and the coupling to the second resonator 1102b can be adjusted essentially completely independently of each other. This is not possible in the embodiments of FIGS. 9 and 10 where any movement of the coupling loop 901 to adjust coupling to the last resonator 902e will inherently cause movement of the coupling plate 903 and thus alter the coupling between plate 903 and the second to last resonator 902d.

Having thus described a few particular embodiments of the invention, various other alterations, modifications, and improvements will readily occur to those skilled in the art. Such alterations, modification and improvements as are made obvious by this disclosure are intended to be part of this description though not expressly stated herein, and are intended to be within the spirit and scope of the invention. Accordingly, the foregoing description is by way of example, and not limiting. The invention is limited only as defined in the following claims and equivalents thereto.

We claim:

1. A mounting system for mounting at least one dielectric resonator in a dielectric resonator circuit comprising:
a circuit enclosure;
a dielectric resonator; and
a thermally conductive post mounting said dielectric resonator on said enclosure.

2. The mounting system of claim 1 wherein said post is electrically conductive.

3. The mounting system of claim 1 wherein said post is comprised of metal.

4. The mounting system of claim 2 further comprising a dielectric insert positioned between said dielectric resonator and said post.

5. The mounting system of claim 4 wherein said dielectric resonator comprises a longitudinal through hole defining an inner radial surface of said resonator and wherein said post passes at least partially through said through hole of said dielectric resonator and said insert comprises an annulus having an outer radial surface sized to contact said inner radial surface of said resonator and an inner radial surface sized to contact said post.

6. The mounting system of claim 5 wherein said insert is compliant, whereby it can absorb changes in relative size of said post and said resonator.

7. The mounting system of claim 1 wherein said post is adapted to permit said dielectric resonator to be longitudinally adjustable relative to said enclosure.

8. The mounting system of claim 7 wherein said post is longitudinally adjustable relative to said enclosure.

9. The mounting system of claim 8 wherein said post passes through a hole in said enclosure, said post and said hole in said enclosure being matingly threaded to provide said longitudinal adjustability by relative rotation of said post and said enclosure.

10. The mounting system of claim 9 further comprising a threaded nut positioned over said threaded portion of said post for locking said post relative to said enclosure.

11. The mounting system of claim 7 wherein said dielectric resonator is coupled to said post by a sliding frictional fit.

12. The mounting system of claim 5 wherein said dielectric resonator is longitudinally adjustable relative to at least one of said insert and said post.

13. The mounting system of claim 12 wherein said longitudinal adjustability is provided by a sliding frictional fit between at least one of (a) said dielectric resonator and said insert and (b) said insert and said post.

14. The mounting system of claim 1 further comprising a tuning plate mounted on said post adjacent said dielectric resonator.

15. The mounting system of claim 14 wherein said tuning plate is longitudinally adjustable relative to said post.

16. The mounting system of claim 15 wherein said tuning plate is mounted on said post by a sliding frictional fit.

17. The mounting system of claim 15 wherein said tuning plate is mounted on said post by a mating thread fit.

18. The mounting system of claim 15 wherein said post comprises first and second longitudinal ends and wherein said first end passes completely though a first through hole in a first wall of said enclosure and said second end passes completely through a second through hole in a second wall of said enclosure opposite said first wall.

19. The mounting system of claim 18 wherein said tuning plate comprises an annulus having an inner radial wall and an outer radial wall, said annulus positioned with its outer radial wall in contact with said second through hole in said enclosure and its inner radial wall in contact with said post and wherein a sliding friction fit is provided between at least one of (a) said annulus and said post and (b) said annulus and said second through hole in said enclosure.

20. The mounting system of claim 19 wherein a mating thread fit is provided between the other of (a) said annulus and said post and (b) said annulus and said second through hole in said enclosure.

21. The mounting system of claim 20 wherein said mating thread fit is provided between said annulus and said post and said system further comprises a second locking nut positioned adjacent said tuning plate for locking said longitudinal position of said tuning plate relative to said post.

22. The mounting system of claim 18 wherein said post passes completely through said tuning plate.

23. The mounting system of claim 2 wherein said post is comprised of a dielectric material plated with a thermally and electrically conductive material.

24. The mounting system of claim 23 wherein said dielectric material of said post is alumina.

25. The mounting system of claim 1;
wherein said dielectric resonator comprises a plurality of dielectric resonators and said post comprises a plurality of posts; and
wherein said enclosure comprises at least one separating wall between at least two of said dielectric resonators and wherein a longitudinal portion of at least one of said posts passes through one of said separating walls.

26. The mounting system of claim 25 wherein said separating wall is thicker than a diameter of said post that passes through it, whereby said longitudinal portion of said post that passes through said separating wall is completely within said separating wall.

27. The mounting system of claim 2 wherein said dielectric resonator comprises a longitudinal through hole and said post passes through said longitudinal through hole.

28. A dielectric resonator circuit comprising:
a circuit enclosure;
a plurality of dielectric resonators;
an input coupler;
an output coupler; and
a thermally conductive post mounting at least one of said dielectric resonators on said enclosure.

29. The circuit of claim 28 wherein said post is electrically conductive

30. The circuit of claim 29 wherein said dielectric resonator comprises a longitudinal through hole and said post passes through said longitudinal through hole.

31. The circuit of claim 29 further comprising a dielectric insert positioned between said dielectric resonator and said post.

32. The circuit of claim 29 wherein said dielectric resonator comprises a longitudinal through hole defining an inner radial surface of said resonator and wherein said post passes at least partially through said through hole of said dielectric resonator and said insert comprises an annulus having an outer radial surface sized to contact said inner radial surface of said resonator and an inner radial surface sized to contact said post.

33. The circuit of claim 32 wherein said insert is compliant, whereby it can absorb changes in relative size of said post and said resonator.

34. The circuit of claim 28 wherein said post is adapted to permit said dielectric resonator to be longitudinally adjustable relative to said enclosure.

35. The circuit of claim 34 wherein said post is longitudinally adjustable relative to said enclosure.

36. The circuit of claim 35 wherein said post passes through a hole in said enclosure, said post and said hole in said enclosure being matingly threaded to provide said longitudinal adjustability by relative rotation of said post and said enclosure.

37. The circuit of claim 32 wherein said dielectric resonator is longitudinally adjustable relative to at least one of said insert and said post.

38. The circuit of claim 34 wherein said dielectric resonator is coupled to said post by a sliding frictional fit.

39. The circuit of claim 28 further comprising a tuning plate mounted on said post adjacent said dielectric resonator.

40. The circuit of claim 39 wherein said tuning plate is longitudinally adjustable relative to said post.

41. The circuit of claim 40 wherein said post comprises first and second longitudinal ends and wherein said first end passes completely though a first through hole in a first wall of said enclosure and said second end passes completely through a second through hole in a second wall of said enclosure opposite said first wall.

42. The circuit of claim 41 wherein said tuning plate comprises an annulus having an inner radial wall and an outer radial wall, said annulus positioned with its outer radial wall in contact with said second through hole in said enclosure and its inner radial wall in contact with said post and wherein a sliding friction fit is provided between at least one of (a) said annulus and said post and (b) said annulus and said second through hole in said enclosure.

43. A dielectric resonator circuit comprising:
a circuit enclosure;
a plurality of dielectric resonators;
a first coupler for coupling to further circuitry without said enclosure, said first coupler comprising a first coupling element adapted and positioned to couple to a first one of said dielectric resonators and a second coupling element adapted and positioned to couple to a second one of said dielectric resonators; and
a second coupler for coupling to further circuitry without said enclosure adapted and positioned to couple to a third one of said dielectric resonators.

44. The dielectric resonator circuit of claim 43 wherein said first coupling element is adapted and positioned to magnetically couple to said first dielectric resonator and said second coupling element is adapted to electrically couple to said second dielectric resonator.

45. The dielectric resonator circuit of claim 44 wherein said first coupling element comprises a wire and said second coupling element comprises a plate.

46. The dielectric resonator of claim 45 wherein said plate is formed of copper.

47. The dielectric resonator circuit of claim 45 wherein said plate is suspended from an end of said wire.

48. The dielectric resonator circuit of claim 47 wherein said wire curves around said first dielectric resonator and said plate is suspended adjacent said second dielectric resonator.

49. The dielectric resonator circuit of claim 48 wherein said dielectric resonators are of a shape selected from the group cylindrical and conical and have longitudinal axes, and wherein said plate is oriented parallel to said longitudinal axis of said second resonator.

50. The dielectric resonator circuit of claim 49 wherein said longitudinal axes of all of said plurality of resonators are parallel and wherein said plate is oriented perpendicular to said longitudinal axes of said plurality of resonators.

51. The dielectric resonator of claim 43 wherein said second coupler comprises a third coupling element, said third coupling element comprising a wire that curves around said third dielectric resonator and magnetically couples to said third dielectric resonator, said wire curve comprising a portion bowed outwardly adjacent a fourth dielectric resonator of said circuit so as to cause said third coupling element to magnetically couple to said fourth dielectric resonator.

52. The dielectric resonator of claim 43 wherein said first coupler is an output coupler.

53. The dielectric resonator circuit of claim 52 wherein said second coupler comprises a coupling element, said coupling element comprising a wire that curves around said third dielectric resonator and magnetically couples to said third dielectric resonator, said wire curve comprising a portion bowed outwardly adjacent a fourth dielectric resonator of said circuit so as to cause said coupler to magnetically couple to said fourth dielectric resonator.

54. A dielectric resonator circuit comprising:
a circuit enclosure;
a plurality of dielectric resonators;
a first coupler, said first coupler comprising a coupling element adapted and positioned to couple to a first one and a second one of said dielectric resonators, wherein said first coupling element comprises a wire that curves around said first dielectric resonator, said wire curve comprising a portion bowed outwardly adjacent a second one of said dielectric resonators so as to cause said coupler to magnetically couple to said first and second dielectric resonators; and
a second coupler adapted and positioned to couple to a third one of said dielectric resonators.

55. A dielectric resonator circuit comprising:
a circuit enclosure;
a plurality of dielectric resonators arranged to electromagnetically couple to each other in sequence, wherein said dielectric resonators have longitudinal axes and are mounted to said enclosure with their longitudinal axes parallel to each other;
a first coupler comprising a first coupling element positioned to couple to a first one of said sequential dielectric resonators; and
a second coupler comprising a second coupling element positioned to couple to a last one of said sequential dielectric resonators;
wherein said spacing between said sequentially adjacent dielectric resonators of said plurality of dielectric resonators is non-uniform in a direction lateral to said longitudinal axes, wherein a strength of said coupling between adjacent dielectric resonators is dependent upon said lateral spacing.

56. The dielectric resonator circuit of claim 55 wherein there are no irises between said dielectric resonators.

57. The dielectric resonator circuit of claim 55 wherein said first coupler is mounted in said enclosure between said first resonator and a sequentially second resonator, whereby said first coupler may be adapted to electromagnetically couple to one or both of said first and second resonators.

58. The dielectric resonator circuit of claim 55 wherein said second coupler is mounted in said enclosure between said last resonator and a sequentially second to last resonator, whereby said second coupler may be adapted to electromagnetically couple to one or both of said last resonator and said sequentially second to last resonator.

59. The dielectric resonator circuit of claim 57 wherein said second coupler is mounted in said enclosure between said last resonator and a sequentially second to last resonator, whereby said second coupler may be adapted to electromagnetically couple to one or both of said last resonator and said sequentially second to last resonator.

60. The dielectric resonator circuit of claim 57 wherein said first coupler comprises first and second coupling elements, said first coupling element adapted to couple to said first dielectric resonator and said second coupling element adapted to couple to said second dielectric resonator.

61. The dielectric resonator circuit of claim 60 wherein said first coupling element comprises a first wire positioned and shaped to magnetically couple to said first dielectric resonator and said second coupling element comprises a second wire positioned and shaped to magnetically couple to said second dielectric resonator.

62. The dielectric resonator circuit of claim 60 wherein said first coupling element comprises a wire positioned and shaped to magnetically couple to said first dielectric resonator and said second coupling element comprises a plate positioned and shaped to electrically couple to said second dielectric resonator.

63. A dielectric resonator circuit comprising:
a circuit enclosure;
a plurality of dielectric resonators;
a first coupler, said first coupler comprising a first coupling element adapted and positioned to magnetically couple to a first one of said dielectric resonators and a second coupling element adapted and positioned to cross-couple to a second one of said dielectric resonators;
an elongate cross-coupling tuning element passing through an opening in said enclosure and having a proximal end without said enclosure and a distal end within said enclosure, said distal end positioned adjacent said second coupling element, said cross-coupling tuning element longitudinally adjustable within said hole such that said distal end can engage said second coupling element and forcibly move said second coupling element relative to said second dielectric resonator, whereby a cross-coupling strength of said second coupling element with said second dielectric resonator is adjusted by longitudinal movement of said cross-coupling tuning element; and
a second coupler adapted and positioned to couple to a third one of said dielectric resonators.

64. The dielectric resonator circuit of claim 63 wherein said elongate cross-coupling tuning element comprises a threaded screw and wherein said opening comprises a matingly threaded hole, whereby said longitudinal movement of said cross-coupling tuning element is effected by rotation of said screw in said hole.

65. The dielectric resonator circuit of claim 64 wherein said distal end of said screw is coupled to said second coupling element via a rotational coupling.

66. The dielectric resonator circuit of claim 63 wherein said first coupling element comprises a wire and said second coupling element comprises a plate coupled to said wire, wherein said distal end of said screw butts against said plate and moves said plate against a resilient force of said wire.

67. The dielectric resonator of claim 66 wherein said distal end of said screw is hollow and wherein said second coupling element further comprises a cylinder that fits rotatably within said hollow portion of said screw.

68. The dielectric resonator of claim 67 wherein said cylinder has a butting fit with said hollow portion of said screw.

69. The dielectric resonator of claim 67 further comprising a rotational coupling between said cylinder and said distal end of said screw.
